(19) United States
(12) Patent Application Publication
(10) Pub. No.: US 2007/0105585 A1
(43) Pub. Date: May 10, 2007

(54) Apparatus and method for constructing neighbor node list in cellular communication system

(75) Inventors: Sung-Jin Lee, Seoul (KR); Pan-Yuh Joo, Seoul (KR); Jung-Je Son, Seongnam-si (KR); Jae-Weon Cho, Suwon-si (KR); Hyoung-Kyu Lim, Seoul (KR); Yeong-Moon Son, Anyang-si (KR); Mi-Hyun Lee, Seoul (KR); Hyun-Jeong Kang, Seoul (KR); Song-Nam Hong, Seoul (KR); Young-Ho Kim, Suwon-si (KR)

Correspondence Address: THE FARRELL LAW FIRM, 333 EARLE OVINGTON BOULEVARD., SUITE 701, UNIONDALE, NY, 11553, US

(73) Assignee: Samsung Electronics Co., Ltd., Suwon-si (KR)

(21) Appl. No.: 11/595,080

(22) Filed: Nov. 9, 2006

(30) Foreign Application Priority Data
Nov. 9, 2005 (KR) 2005-106798

(51) Int. Cl. H04Q 7/20

(52) U.S. Cl. 455/525; 455/561; 370/235

(57) ABSTRACT

Provided is an apparatus and method for constructing a neighbor node list in a cellular communication system. In the method, an MS acquires neighbor nodes through a scanning operation in an initial network entry procedure, inserts information about the acquired neighbor nodes into a predetermined message, and transmits the predetermined message to a serving station. The serving station updates a periodically-broadcast neighbor list using the information about the neighbor nodes. The MS does not discard but provides the information about the acquired neighbor nodes to the serving station (BS or RS), thereby making it easy for the serving station to acquire information about neighbor BSs and RSs.

### PRIORITY

This application claims priority under 35 U.S.C. § 119 to an application filed in the Korean Intellectual Property Office on Nov. 9, 2005 and allocated Serial No. 2005-106798, the contents of which are incorporated herein by reference.

### BACKGROUND OF THE INVENTION

1. Field of the Invention

The present invention relates generally to a cellular communication system, and, in particular, to an apparatus and method for constructing a neighbor node list in a Broadband Wireless Access (BWA) communication system using a multi-hop relay scheme.

2. Description of the Related Art

Recently, extensive research is being conducted to provide various Quality of Service (QoS) features with a data rate of about 100 Mbps in the advanced fourth-generation (4G) communication system. The 4G communication system is evolving to provide mobility, high data rate transmission, and high QoS in a Broadband Wireless Access (BWA) system such as a Local Area Network (LAN) system and a Metropolitan Area Network (MAN) system. Examples of the above system are identified in the Institute of Electrical and Electronics Engineers (IEEE) 802.16d system and the IEEE 802.16e system standards.

The IEEE 802.16d system and the BWA system use an Orthogonal Frequency Division Multiplexing (OFDM)/Orthogonal Frequency Division Multiple Access (OFDMA) scheme. The IEEE 802.16d system considers only a fixed Subscriber Station (SS) and a single cell structure (i.e., the mobility of an SS is not considered). The IEEE 802.16e system considers the mobility of an SS. When the mobility of an SS is considered, the SS will be referred to as a Mobile Station (MS).

FIG. 1 is a block diagram of a conventional BWA system. Referring to FIG. 1, the BWA system has a multi-cell structure. The IEEE 802.16e system includes a cell 100, a cell 150, a base station (BS) 110 managing the cell 100, a BS 140 managing the cell 150, and a plurality of MSs 111, 113, 130, 151 and 153. The signal exchange between the BSs 110 and 140 and the MSs 111, 113, 130, 151 and 153 is performed using an OFDM/OFDMA scheme. The MS 130 is located in a boundary region (i.e., a handover region) between the cells 100 and 150. When the MS 130 moves from the cell 100 of the BS 110 into the cell 150 of the BS 140 while communicating with the BS 110, the serving BS of the MS 130 changes from the BS 110 to the BS 140.

In such a BWA system (e.g., an IEEE 802.16 system), a ranging channel is used as an uplink (UL) random access channel. An initial ranging operation, a periodic ranging operation, and a bandwidth request ranging operation are performed using the ranging channel. When an MS enters a network (i.e., a network entry procedure) or loses its system information, it performs an initial ranging operation to achieve UL synchronization. During the initial ranging operation of the MS, a BS measures the precise time of arrival of a ranging signal received from the MS, calculates a Round Trip Delay (RTD) between the BS and the MS, and informs the MS of a timing offset corresponding to the calculated RTD.

FIG. 2 is a flow diagram illustrating an initial ranging procedure in the conventional BWA system. Referring to FIG. 2, when powered on, an MS 201 receives a downlink (DL) preamble from a serving BS 203 to achieve synchronization with the BS 203. In step 204, the MS 201 receives a DL-MAP message and a Downlink Channel Descriptor (DCD) message from the BS 203 and acquires DL channel information from the received messages. In addition, the MS 201 receives a UL-MAP message and an Uplink Channel Descriptor (UCD) message from the BS 203 and acquires UL channel information and initial ranging parameters from the received messages.

Using the acquired UL/DL channel information, the MS 201 performs a basic access procedure, which is called an initial ranging procedure. In the initial ranging procedure, the MS 201 transmits a ranging request (RNG-REQ) message to the BS 203 (step 205) and the BS 203 transmits a ranging response (RNG-RSP) message to the MS 201 in response to the RNG-REQ message (step 207). The messages used for the initial ranging procedure are described in detail below.

Table 1 below illustrates the format of the RNG-REQ message transmitted from the MS to the BS.

TABLE 1

| Syntax | Size | Note |
|---|---|---|
| RNG-REQ_Message_Format( ) { | | |
| Management Message Type = 4 | 8bits | |
| Downlink Channel ID | | |
| TLV encoded Information { | variable | TLV specific |
| SS MAC Address | | |
| Requested Downlink Burst Profile | | |
| MAC Version | | |
| Ranging Anomalies | | |
| AAS broadcast capability | | |
| } | | |
| } | | |

As illustrated in Table 1, the RNG-REQ message includes a plurality of information fields. A “Management Message Type” field has a value of ‘4’ to indicate the RNG-REQ message. “SS MAC Address” is a MAC layer address of the MS and is used as an identifier of the MS. “Downlink Channel ID” indicates a DL channel through which an UCD message including UL channel information is received. “Requested Downlink Burst Profile” includes a 0-3 bit section and a 4-7 bit section. In the 0-3 bit section, a Downlink Interval Usage Code (DIUC) is recorded for requesting formats (e.g., a modulation scheme and an error correction scheme) that are required to receive and transmit physical channel signals. The 4-7 bit section is a section for recording the four Least Significant Bits (LSBs) of a Configuration Change Count field of the UCD message used for ranging request. The BS transmits a predetermined physical channel signal to the MS in accordance with the information stored in the 0-3 bit section.

As also illustrated in Table 1, “MAC Version” indicates the version of a MAC layer used by the MS. “Ranging Anomalies” includes information about whether the MS tries to access the BS at a maximum transmission (TX) power or a minimum TX power. When the BS commands the MS to increase or decrease TX power to correct the TX power, time information, etc., the MS can use the Ranging Anomalies in response to the command of the BS. “AAS broadcast capability” indicates whether the MS is capable of receiving a broadcast message.

Table 2 below illustrates the format of the RNG-RSP message transmitted from the BS to the MS.

TABLE 2

| Syntax | Size | Note |
|---|---|---|
| RNG-RSP_Message_Format( ) { | | |
| Management Message Type = 5 | 8bits | |
| Uplink Channel ID | | |
| TLV encoded Information { | variable | TLV specific |
| SS MAC Address | 6 | |
| Downlink Operational Burst Profile | 2 | |
| Primary Management CID | 2 | |
| Basic CID | 2 | |
| Ranging Status | 4 | 1 = continue |
| | | 2 = abort |
| | | 3 = success |
| | | 4 = rerange |
| Timing adjust | 4 | |
| Power level adjust | 1 | |
| Downlink frequency override | 4 | Center Frequency |
| | | (kHz) allowing an |
| | | SS to perform an |
| | | initial Ranging |
| } | | Request again |
| } | | |

As illustrated in Table 2, the RNG-RSP message includes a plurality of information fields. A “Management Message Type” field has a value of ‘5’ to indicate that the present message is the RNG-RSP message. A “SS MAC Address” field contains a MAC layer address of the MS that will receive the RNG-RSP message. “Downlink Operational Burst Profile” is used as a response to the “Requested Downlink Burst Profile” of the RNG-REQ message from the MS and indicates a DIUC number that will be used by the BS. “Uplink Channel ID” indicates a UL channel for the MS. “Primary Management CID” and “Basic CID” are CIDs that are assigned to the MS by the BS in order to manage the connection between the BS and the MS while the MS receives a service from the BS after a ranging procedure.

As also illustrated in Table 2, “Ranging Status” indicates a response of the BS to a ranging request of the MS. When the Ranging Status field has a value of ‘1’, it indicates the need to continue the ranging process. When the Ranging Status field has a value of ‘2’, it indicates the need to abort (stop) the ranging process. When the Ranging Status field has a value of ‘3’, it indicates the success of the ranging process. When the Ranging Status field has a value of ‘4’, it indicates the need to perform the ranging request again.

As further illustrated in Table 2, “Timing Adjust” contains information that enables the MS to correct incorrect time information. “Power Level Adjust” contains information that enables the MS to adjust its TX/RX power. “Downlink Frequency Override” is used to inform the MS of a frequency value of another channel, so that the MS can again perform an initial ranging request with another frequency when the Ranging Status field is set to ‘2’ indicating the need to abort the ranging process.

After the ranging procedure is completed to achieve synchronization with the BS and to establish basic environments for communication with the BS (e.g., adjustment of power), the remaining initial network entry procedure (e.g., a basic capability negotiation process, an authorization process and a registration process) are performed to complete connection to the BS.

Because a signaling communication between a stationary BS and an MS is performed through a direct link as illustrated in FIG. 1, the IEEE 802.16e system can easily provide a highly reliable wireless link between the BS and the MS. However, because the BS is stationary, the IEEE 802.16e system has a low flexibility in constructing a wireless network. Accordingly, use of the IEEE 802.16e system makes it difficult to provide an efficient communication service in a radio environment where traffic distribution or call requirements change frequently.

In order to overcome this problem, a stationary or fixed Relay Station (RS), a mobile RS or general MSs can be used to apply a multi-hop relay data transmission scheme to a general cellular communication system such as the IEEE 802.16e system. The use of the multi-hop relay wireless communication system makes it possible to reconfigure a network in rapid response to a change in the communication environment and to operate the entire wireless network more efficiently. For example, the multi-hop relay wireless communication system can expand a cell coverage area and increase system capacity. When channel conditions between a BS and an MS are poor, an RS is installed between the BS and the MS to establish a multi-hop relay link therebetween, thereby making it possible to provide the MS with a radio channel having better channel conditions. In addition, the multi-hop relay scheme is used in a cell boundary region with poor channel conditions, thereby making it possible to provide a high-rate data channel and to expand the cell coverage area.

FIG. 3 is a block diagram illustrating a BWA system that uses a multi-hop relay scheme to expand a BS coverage area. Referring to FIG. 3, the multi-hop relay BWA system has a multi-cell structure. The multi-hop relay BWA system includes a cell 300, a cell 340, a BS 310 managing the cell 300, a BS 350 managing the cell 340, a plurality of MSs 311 and 313 located within the cell 300, a plurality of MSs 321 and 323 located in a region 330 outside the cell 300 of the BS 310 yet communicating with the BS 310, an RS 320 providing a multi-hop relay path between the BS 310 and the MSs 321 and 323 located in the region 330, a plurality of MSs 351, 353 and 355 located in the cell 340, a plurality of MSs 361 and 363 located in a region 370 outside the cell 340 of the BS 350 yet communicating with the BS 350, and an RS 360 providing a multi-hop relay path between the BS 350 and the MSs 361 and 363 located in the region 370. An OFDM/OFDMA scheme is used for communication among the BS 310 and 350, the RS 320 and 360, and the MSs 311, 313, 321, 323, 351, 353, 355, 361, and 363.

Although the MSs 311 and 313 located in the cell 300 and the RS 320 can directly communicate with the BS 310, the MSs 321 and 323 located in the region 330 cannot directly communicate with the BS 310. Therefore, the RS 320 covers the region 330 to relay signals between the BS 310 and the MSs 321 and 323. That is, the MSs 321 and 323 can communicate with the BS 310 through the RS 320.

Further, the RS 360 and the MSs 351, 353, and 355 located in the cell 340 can directly communicate with the BS 350. However, the MSs 361 and 363 located in the region 370 cannot directly communicate with the BS 350. Therefore, the RS 360 covers the region 370 to relay signals between the BS 350 and the MSs 361 and 363. That is, the MSs 361 and 363 can communicate with the BS 350 through the RS 360.

As described above, in the multi-hop relay BWA system, the MS can communicate with the BS via a direct link and also can communicate with the BS via the RS when it cannot communicate with the BS via the direct link. Therefore, operations must be defined so that the multi-hop relay BWA system can also support services and functions that are provided by a conventional wireless communication system.

For example, because a target of communication with the MS is expanded to include the RS as well as the BS, the MS must be able to scan neighbor RSs as well as neighbor BSs. To this end, the MS must receive information about neighbor BSs and neighbor RSs from a serving station (RS or BS). However, a method of providing the MS with information about neighbor BSs and all neighbor RSs connected to the neighbor BSs is impossible to implement, due to a limited transport capacity.

FIG. 4 is a diagram illustrating the distribution of BSs and RSs in the multi-hop relay BWA system. FIG. 4 illustrates a case where each BS (or cell) includes ten RSs by way of example. However, it will be apparent to those skilled in the art that each BS may include a larger (smaller) number of RSs.

Referring to FIG. 4, an MS 411 communicates with a BS1 401 through a serving relay station RS8 As shown in FIG. 4, BS2 403 and BS3 405 neighbor BS1 401. At this point, so that the MS 411 can scan all the neighbor nodes, the serving relay station RS8 must transmit to the MS 411 information about not only the BS2 403 and the BS3 405 but also about RSs connected to the two BSs 403 and 405 (i.e., information about 2 neighbor BSs and also about the 20 neighbor RSs shown in FIG. 4 associated with BS2 403 and BS3 405).

In general, a mobile communication network manages information about several tens of neighbor BSs and broadcasts the information to MSs. Therefore, if 20 neighbor BSs, each having 10 RSs, exist in the multi-hop relay BWA system, an MS must be provided with information about a total of 220 nodes. Accordingly, too many resources are wasted in transmitting control information, rather than transmitting actual traffic data.

As described above, it is inefficient for the conventional multi-hop relay BWA system to provide an MS with information about all neighbor RSs as well as neighbor BSs.

### SUMMARY OF THE INVENTION

An object of the present invention is to substantially solve at least the above problems and/or disadvantages and to provide at least the advantages below. Accordingly, an object of the present invention is to provide an apparatus and method for a multi-hop relay BWA system for constructing a neighbor node list on the basis of the scanning results received from an MS.

Another object of the present invention is to provide an apparatus and method for a multi-hop relay BWA system for scanning neighbor nodes at an MS in an initial network entry mode and reporting the scanning results to a serving station.

A further object of the present invention is to provide an apparatus and method for a multi-hop relay BWA system for optimizing a broadcast neighbor node list using information about nodes that can be acquired by an MS.

According to one aspect of the present invention, there is provided a communication method of an MS in a cellular communication system, including acquiring neighbor nodes through a scanning operation in an initial network entry mode; and transmitting information about the acquired neighbor nodes to a serving station.

According to another aspect of the present invention, there is provided a communication method of a serving station in a cellular communication system, determining if a predetermined message is received from an MS performing an initial network entry procedure; if the predetermined message is received, determining if the received message includes information about neighbor nodes; and if the received message includes the information about the neighbor nodes, updating a periodically-broadcast neighbor node list using the information about the neighbor nodes.

According to a further aspect of the present invention, there is provided an MS apparatus for a cellular communication system, including a scanning unit for acquiring neighbor nodes in an initial network entry mode; a controller for selecting the neighbor node with the highest RX signal strength as a serving node and providing information about information of neighbor nodes satisfying a predetermined criterion; a message generator for generating a message including the information about the neighbor nodes satisfying the predetermined criterion; and a transmitter for processing the generated message in accordance with a predetermined wireless standard and transmitting the processed message to the serving station through an antenna.

According to still another aspect of the present invention, there is provided a serving station apparatus for a cellular communication system, including a database for managing a neighbor node list that is broadcast periodically; a message processor for processing a message that is received from an MS performing an initial network entry procedure; and a controller for updating the neighbor node list using information of neighbor nodes that is included in a predetermined message received from the MS.

According to yet another aspect of the present invention, there is provided a method for constructing a neighbor node list in a cellular communication system, including acquiring neighbor nodes at an MS through a scanning operation in an initial network entry procedure, inserting information about the acquired neighbor nodes into a predetermined message, and transmitting the predetermined message to a serving station; and updating a periodically-broadcast neighbor list at the serving station on the basis of the information about the neighbor nodes.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a conventional BWA system;

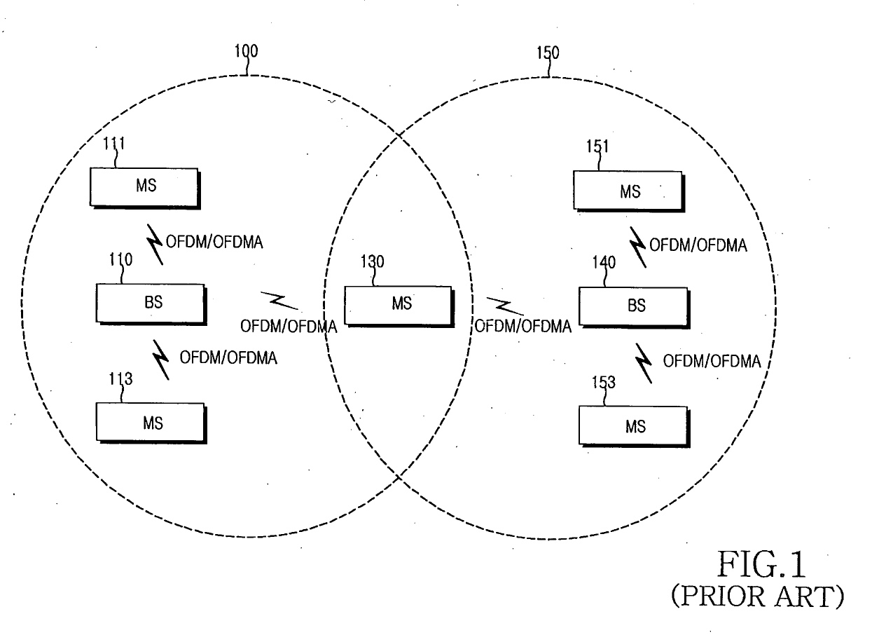

FIG. 2 is a flow diagram illustrating an initial ranging procedure in the conventional BWA system;

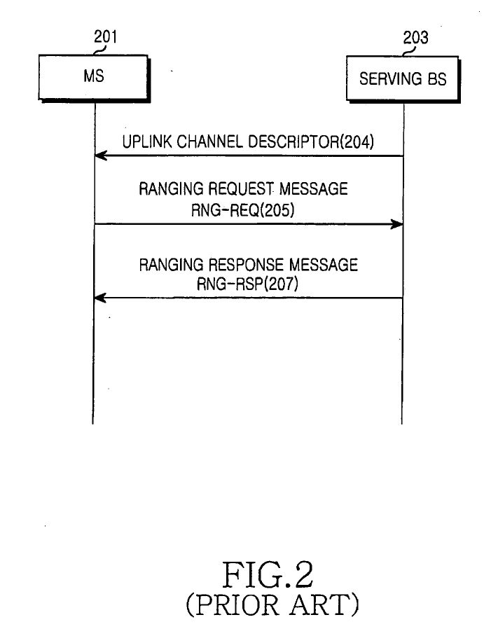

FIG. 3 is a block diagram illustrating a BWA system that uses a multi-hop relay scheme to expand a BS coverage area;

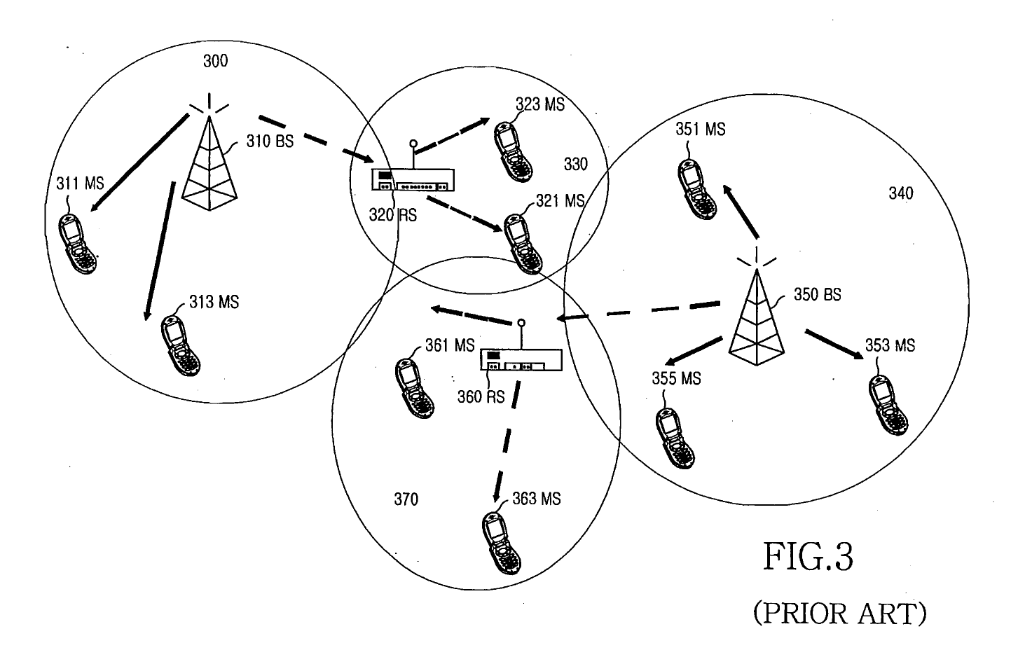

FIG. 4 is a diagram illustrating the distribution of BSs and RSs in the multi-hop relay BWA system;

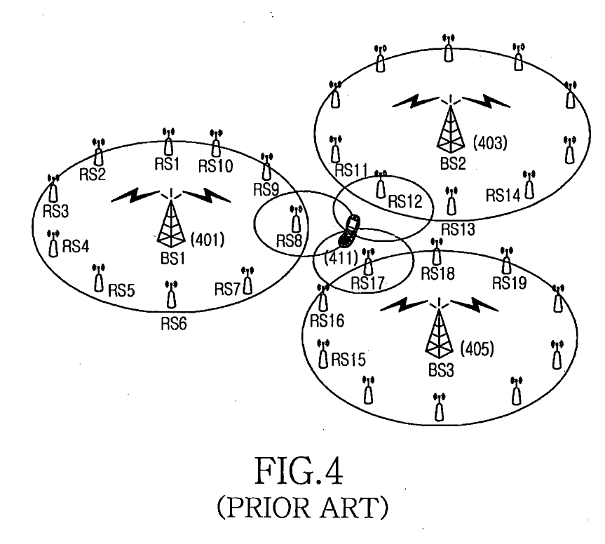

FIG. 5 is a flow diagram illustrating an overall signaling procedure for constructing a neighbor node list in a multi-hop relay BWA system according to the present invention;

FIG. 6 is a flowchart illustrating an operation of an MS for initial network entry in a multi-hop relay BWA system according to the present invention;

FIG. 7 is a flowchart illustrating an operation of a serving station for constructing a neighbor node list in a multi-hop relay BWA system according to the present invention; and

FIG. 8 is a block diagram of an MS (or a serving station) in a multi-hop relay BWA system according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail to avoid obscuring the invention with unnecessary detail. Also, the terms used herein are defined according to the functions of the present invention. Thus, the terms may vary depending on user's or operator's intension and usage. That is, the terms used herein must be understood based on the descriptions made herein.

The present invention provides an apparatus and method for updating a neighbor node list in a multi-hop relay BWA system by providing a serving station with information about neighbor nodes that are scanned by an MS in an initial network entry mode. Hereinafter, the term “node” is used to refer to both of a BS and an RS.

The multi-hop relay BWA system uses an OFDM scheme or an OFDMA scheme, for example. Accordingly, the multi-hop relay BWA system can transmit physical channel signals using a plurality of subcarriers, thereby enabling high-rate data transmission. In addition, the multi-hop relay BWA system supports a multi-cell structure, thereby supporting the mobility of an MS. Although a multi-hop relay BWA system is used as an example in the following description, the present invention can be applied to any cellular communication system that uses a multi-hop relay scheme.

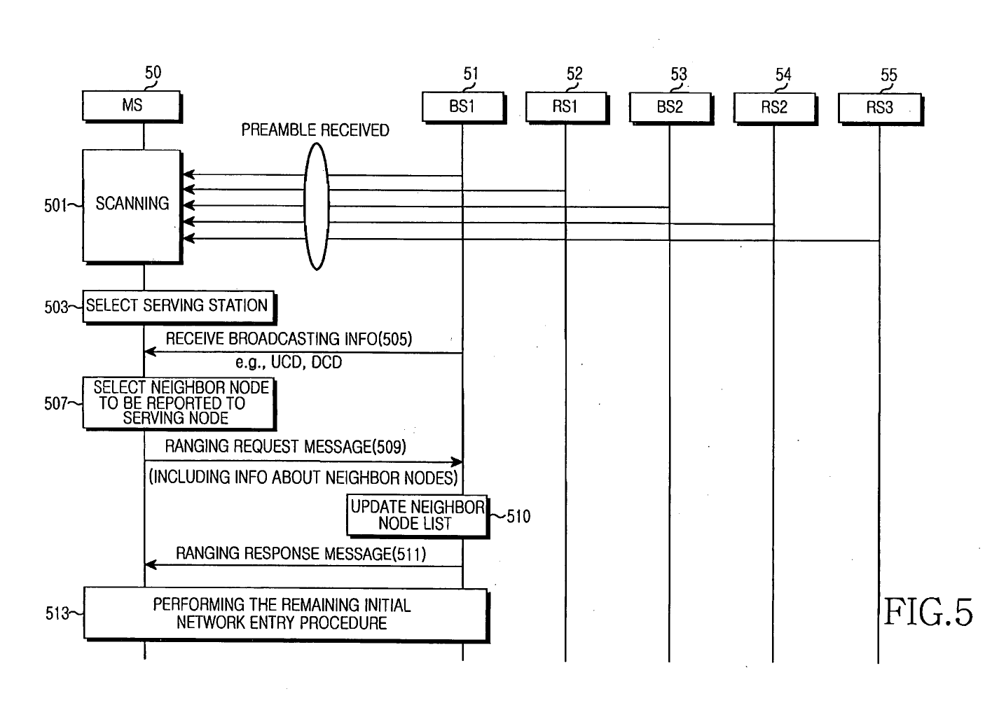

FIG. 5 is a flow diagram illustrating an overall signaling procedure for constructing a neighbor node list in a multi-hop relay BWA system according to the present invention. As illustrated in FIG. 5, it is assumed that a BS1 51, an RS1 52, a BS2 53, an RS2 54 and an RS3 55 neighbor an MS 50.

Referring to FIG. 5, when powered on, the MS 50 scans neighbor nodes using given information (e.g., frequencies and preamble indexes), in step 501. At this point, it is assumed that the MS 50 has acquired DL preamble signals of the BS1 51, the RS1 52, the BS2 53, the RS2 54 and the RS3 55.

In step 503, the MS 50 selects the BS1 51 with the highest RX signal strength as a serving station, arranges the remaining neighbor nodes in the order of RX signal strength, and stores information about the arranged neighbor nodes in a neighbor node management table. Examples of the stored information are node identifiers (IDs), preamble indexes, and RX signal strengths.

In step 505, the MS 50 acquires system synchronization with the BS1 51 and receives broadcasting information from the BS1 51. At this point, for example, the MS 50 receives a MAP message, a Downlink Channel Descriptor (DCD) message, and an Uplink Channel Descriptor (UCD) message from the BS1 51 and acquires physical channel information and initial ranging parameters from the received messages.

In step 507, the MS 50 searches the stored neighbor node information to select neighbor nodes to be reported to the BS1 51. At this point, the MS 50 may select neighbor nodes whose RX signal strength is greater than a predetermined threshold. Alternatively, the MS 50 may select a predetermined number of neighbor nodes in the descending order of RX signal strength.

In step 509, the MS 50 transmits to the BS 151 a ranging request (RNG-REQ) message including information about the selected neighbor nodes. At this point, the information about the selected neighbor nodes may include node IDs (e.g., MAC addresses and preamble indexes) and RX signal strengths (or signal arrival delays) and may be inserted into the ranging request message in Type/Length/Value (TLV) format.

In step 510, the BS1 51 receives the ranging request message from the MS 50, extracts the information of the selected neighbor nodes from the received ranging request message, and adds the extracted information to a neighbor node list that is broadcast periodically. In step 511, the BS1 51 transmits a ranging response (RNG-RSP) message to the MS 50 in response to the ranging request message, thereby completing an initial ranging procedure.

In step 513, the MS 50 and the BS1 51 perform the remaining initial network entry procedure. Examples of the remaining initial network entry procedure include a basic capability negotiation process, an authorization process, and a registration process.

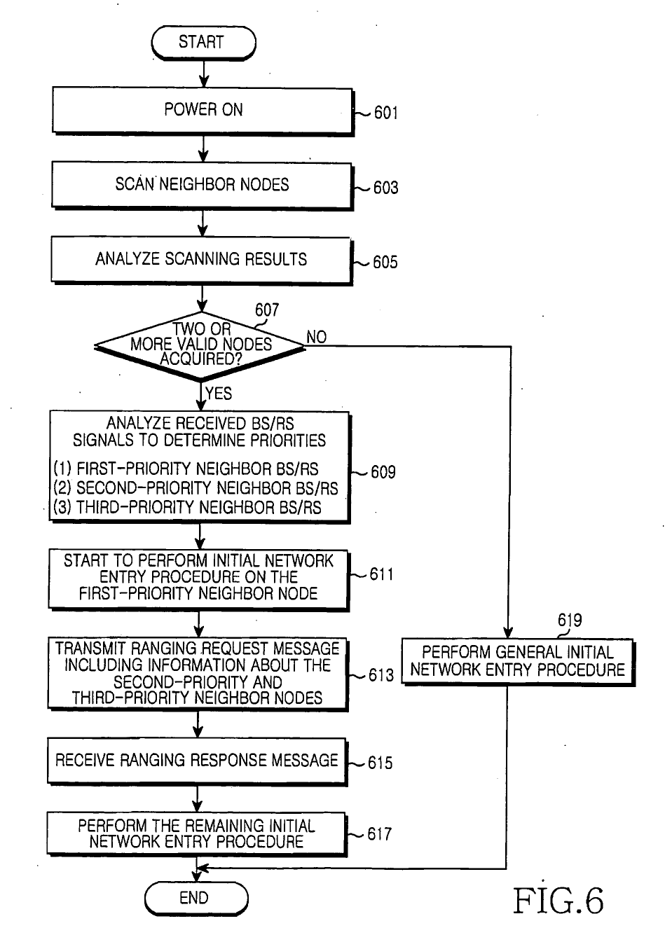

FIG. 6 is a flowchart illustrating an operation of an MS for initial network entry in a multi-hop relay BWA system according to the present invention. Referring to FIG. 6, when powered on in step 601, the MS scans neighbor nodes (BSs and RSs) using given information (e.g., frequencies and preamble indexes), in step 603. In step 605, the MS analyzes the scanning results. In step 607, the MS determines if two or more valid neighbor nodes are acquired (detected). If so, the operation proceeds to step 609; and if not (i.e., if only one valid neighbor node is acquired), the operation proceeds to step 619. In step 619, the MS performs a general initial network entry procedure.

In step 609, the MS arranges the acquired neighbor nodes in accordance with a predetermined criterion (e.g., RX signal strength) and determines the priorities of the acquired neighbor nodes. At this point, the first-priority neighbor node (BS or RS) is selected as a serving station that will communicate with the MS.

In step 611, the MS starts to perform an initial network entry procedure on the serving station (i.e., the first-priority neighbor node). At this point, the MS acquires system synchronization with the serving station and receives broadcasting information from the serving station. For example, the MS receives a MAP message, a DCD message, and a UCD message from the serving station and acquires physical channel information and initial ranging parameters from the received messages. In this way, the MS acquires information for an initial ranging procedure.

In step 613, the MS selects a predetermined number of neighbor nodes among the acquired neighbor nodes except the first-priority neighbor node, and transmits to the serving station a ranging request (RNG-REQ) message including information about the selected neighbor nodes. At this point, the information about the selected neighbor nodes may include node IDs (e.g., MAC addresses and preamble indexes) and RX signal strengths (or signal arrival delays) and may be inserted into the ranging request message in Type/Length/Value (TLV) format.

In step 615, the MS receives a ranging response (RNG-RS) message from the serving station, thereby completing an initial ranging procedure.

In step 617, in association with the serving station, the MS performs the remaining initial network entry procedure. Examples of the remaining initial network entry procedure include a basic capability negotiation process, an authorization process, and a registration process.

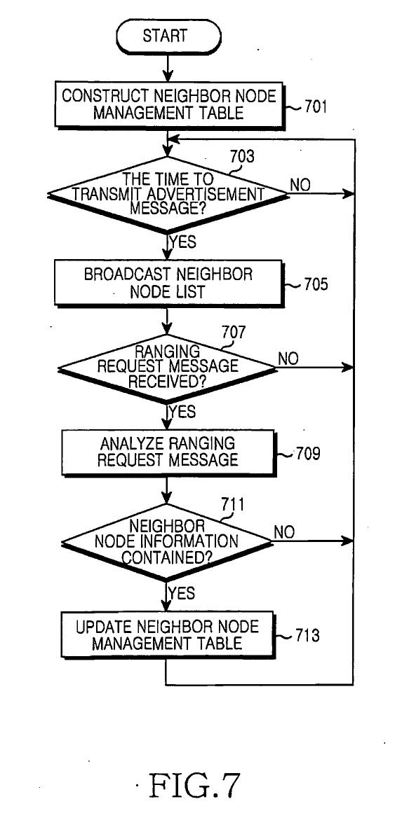

FIG. 7 is a flowchart illustrating an operation of a serving station for constructing a neighbor node list in a multi-hop relay BWA system according to the present invention. The serving station may be a BS or an RS. Referring to FIG. 7, the serving station constructs a neighbor node management table on the basis of given information, in step 701. If the serving station is a BS, the neighbor node management table may be constructed using information about neighbor BSs that can be provided through a backbone network. If the serving station is an RS, the neighbor node management table may be constructed using information about infrastructure nodes that is provided from a serving BS.

In step 703, the serving station determines if a neighbor node list is to be transmitted at the present time. If so, the operation proceeds to step 705; and if not, step 703 is repeated.

In step 705, the serving station broadcasts a neighbor node list (or a neighbor node advertisement message), which is managed using the neighbor node management table, to MSs that are located within a service coverage area. At this point, the neighbor node list may be broadcast periodically.

In step 707, the serving station determines if a ranging request (RNG-REQ) message is received from an MS. If so, the operation proceeds to step 709; and, if not, the operation returns to step 703. In step 709, the serving station analyzes the received ranging request message.

In step 711, the serving station determines if information about neighbor nodes is contained in the received ranging request message. If so, the operation proceeds to step 713; and, if not, the operation returns to step 703. In step 713, the serving station adds the information about the neighbor nodes to the neighbor node management table. Thereafter, the operation returns to step 703.

Configurations of the MS and the serving station (RS or BS) are described in detail below. The MS and the serving station using the same interface module (communication module) are similarly configured and, accordingly, the configurations of the MS and the serving station will be described with reference to one block diagram.

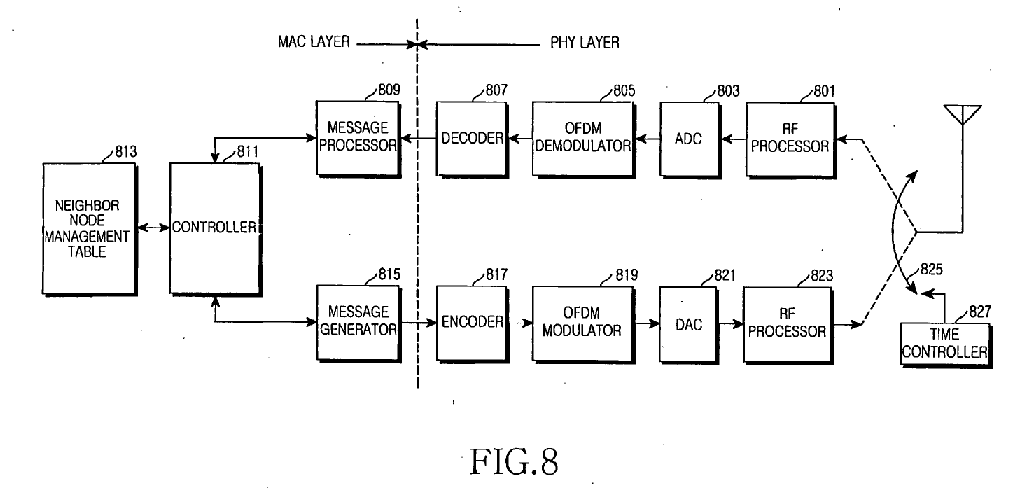

FIG. 8 is a block diagram of an MS (or a serving station) in a multi-hop relay BWA system according to the present invention. Although not so limited, the following description assumes that the MS (or the serving station) uses a Time Division Duplex (TDD)/OFDMA scheme, focusing on control message processing.

Referring to FIG. 8, the MS (or the serving station) includes an antenna, an RX Radio Frequency (RF) processor 801, an Analog-to-Digital Converter (ADC) 803, an OFDM demodulator 805, a decoder 807, a message processor 809, a controller 811, a neighbor node management table 813, a message generator 815, an encoder 817, an OFDM modulator 819, a Digital-to-Analog Converter (DAC) 821, a TX RF processor 823, a switch 825, and a time controller 827.

The time controller 827 controls a switching operation of the switch 825 based on frame synchronization. For example, when in an RX section of a frame, the time controller 827 controls the switch 825 so that the antenna is connected to the RX RF processor 801. When in a TX section of the frame, the time controller 827 controls the switch 825 so that the antenna is connected to the TX RF processor 823.

In the RX section of the frame, the RX RF processor 801 converts an RF signal received through the antenna into a baseband analog signal. The ADC 803 converts the analog signal into sample data (digital data). The OFDM demodulator 805 Fast Fourier Transform (FFT) processes the sample data to output frequency-domain data.

The decoder 807 selects data of desired subcarriers from the frequency-domain data, and decodes the selected data in accordance with a predetermined Modulation & Coding Scheme (MCS) level.

The message processor 809 processes a control message from the decoder 807 and provides the resulting information to the controller 811. The controller 811 processes the information received from the message processor 809 and, if necessary, provides the results of the processing to the message generator 815.

The neighbor node management table 813 is a database for managing information about neighbor nodes. The information about the neighbor node may include a node ID, a preamble index, RX signal strength, and a signal arrival delay (e.g., an RTD). The RX signal strength information may be a Carrier-to-Interference plus Noise Ratio (CINR) or a Received Signal Strength Indicator (RSSI). If the device illustrated in FIG. 8 is the MS, the neighbor node management table 813 manages information about neighbor nodes that are acquired through a scanning operation of the MS. If the device illustrated in FIG. 8 is the serving station, the neighbor node management table 813 manages a neighbor node list to be broadcast periodically.

The message generator 815 generates a message using a variety of information received from the controller 811 and provides the message to the encoder 817.

The encoder 817 encodes data received from the message generator 815 in accordance with a predetermined MCS level. The OFDM modulator 819 Inverse Fast Fourier Transform (IFFT) processes data received from the encoder 817, thereby generating sample data (OFDM symbols). The DAC 821 converts the sample data into an analog signal. The TX RF processor 823 converts the analog signal received from the DAC 821 into an RF signal and transmits the RF signal through the antenna.

In the above-described configuration, the controller 811 is a protocol controller that controls the message processor 809, the message generator 815, and the neighbor node management table 813. The controller 811 can perform the functions of the message processor 809, the message generator 815, and the neighbor node management table 813. Although separate units are provided for respective functions of the controller 811, the controller 811 can perform all or some of the functions instead of such separate units.

Operations of the MS, the RS, and the BS will now be described with reference to the configuration shown in FIG. 8, focusing on a control message processing in a MAC layer.

The operation of the MS will be first described. In an initial network entry mode, a scanning unit (not illustrated) of a physical layer scans neighbor nodes (BSs and RSs) using given information (frequencies and preamble indexes), and provides information about acquired neighbor nodes to the controller 811 of a MAC layer.

The controller 811 arranges the information about the neighbor nodes and stores the arranged information in the neighbor node management table 813. In addition, the controller 811 selects a neighbor node with the highest RX signal strength as a serving station and performs an initial network entry procedure.

In an initial ranging procedure, the controller 811 reads from the neighbor node management table 813 information about neighbor nodes that satisfy a predetermined criterion, and provides the read information to the message generator 815. At this point, the MS may select neighbor nodes whose RX signal strength is higher than a predetermined threshold. Alternatively, the MS may select a predetermined number of neighbor nodes in the descending order of RX signal strength.

Under the control of the controller 811, the message generator 815 generates a ranging request message (as in Table 1) containing information about the neighbor nodes in TLV format, and provides the generated ranging request message to the encoder 817 of the physical layer. The generated ranging request message is processed in a format suitable for the physical layer and is transmitted through the antenna to the serving station.

The operation of the serving station will now be described. The message processor 809 of the serving station analyzes a message received from the MS and provides the results to the controller 811. According to the present invention, if a ranging request message is received from the MS, the message processor 809 extracts a variety of control information from the received ranging request message and provides the extracted control information to the controller 811.

The controller 811 performs operations corresponding to the control information received from the message processor 809. According to the present invention, the controller 811 determines if the received ranging request message contains information about neighbor nodes. If so, the controller 811 adds the information about the neighbor nodes to the neighbor node management table 813 to update a neighbor node list.

If a neighbor node list is to be transmitted at the present time, the controller 811 reads the neighbor node list from the neighbor node management table 813 and provides the a neighbor node list to the message generator 815.

Under the control of the controller 811, the message generator 815 generates a neighbor node advertisement message containing the neighbor node list and provides the same to the physical layer. The neighbor node advertisement message is used to broadcast information about nodes (BSs and RSs) neighboring on the serving station to MSs that are located within a service coverage area. The generated neighbor node advertisement message is processed suitable for the physical layer and is broadcast through the antenna.

As described above, the ranging request message of the ranging procedure in the initial network entry procedure is used to provide the information about the neighbor nodes (BSs and RSs) to the serving station. In another embodiment, the information about the neighbor nodes may be contained in any message transmitted from the MS to the BS in the initial network entry procedure. In a further embodiment, a separate message (of a signaling procedure) may be defined to provide the information about the neighbor nodes to the serving station.

As described above, the MS acquires neighbor nodes through a scanning operation in an initial network entry mode. The MS does not discard but provides information about the acquired neighbor nodes to the serving station (BS or RS), thereby making it easy for the serving station to acquire information about the neighbor BS and RS. In addition, the serving station can provide a neighbor node list for neighbor nodes that are actually detected by the MS. Therefore, it is possible to enhance the accuracy of the neighbor node advertisement message broadcast from the serving station and to optimize the neighbor node list. Accordingly, it is possible to prevent a waste of resources that may occur due to transmission of information of all the neighbor nodes.

While the invention has been shown and described with reference to certain preferred embodiments thereof, it will be understood by those skilled in the art that various changes in form and details may be made therein without departing from the spirit and scope of the invention, as defined by the appended claims.

What is claimed is:

1. A communication method of a Mobile Station (MS) in a cellular communication system, comprising the steps of:
acquiring neighbor nodes through a scanning operation in an initial network entry mode; and
transmitting information about the acquired neighbor nodes to a serving station.

2. The communication method of claim 1, wherein the serving station is a Base Station (BS) or a Relay Station (RS).

3. The communication method of claim 1, wherein a neighbor node with a highest RX signal strength is selected as the serving station.

4. The communication method of claim 1, wherein a predetermined number of the neighbor nodes are selected among the acquired neighbor nodes in descending order of RX signal strength, and information about the selected neighbor nodes is transmitted to the serving station.

5. The communication method of claim 1, wherein the information about the neighbor nodes is inserted into one of messages that are transmitted to the serving station in an initial network entry procedure.

6. The communication method of claim 1, wherein the information about the neighbor nodes is inserted into a ranging request message that is transmitted to the serving station.

7. A communication method of a serving station in a cellular communication system, comprising the steps of:
determining if a predetermined message is received from a Mobile Station (MS) performing an initial network entry procedure;
if the predetermined message is received, determining if the received message includes information about neighbor nodes; and
if the received message includes the information about the neighbor nodes, updating a periodically-broadcast neighbor node list using the information about the neighbor nodes.

8. The communication method of claim 7, wherein the serving station is a Base Station (BS) or a Relay Station (RS).

9. The communication method of claim 7, wherein the neighbor node list includes information about neighbor BSs and neighbor RSs.

10. The communication method of claim 7, wherein the predetermined message is a message for performing an initial network entry procedure.

11. The communication method of claim 7, wherein the predetermined message is a ranging request message.

12. A Mobile Station (MS) apparatus for a cellular communication system, comprising:
a scanning unit for acquiring neighbor nodes in an initial network entry mode;
a controller for selecting the neighbor node with a highest RX signal strength as a serving node and providing information about neighbor nodes satisfying a predetermined criterion;
a message generator for generating a message including the information about the neighbor nodes satisfying the predetermined criterion; and
a transmitter for processing the generated message in accordance with a predetermined wireless standard and transmitting the processed message to the serving station via an antenna.

13. The MS apparatus of claim 12, wherein the serving station is a Base Station (BS) or a Relay Station (RS).

14. The MS apparatus of claim 12, wherein the controller selects a predetermined number of the neighbor nodes among the acquired neighbor nodes in descending order of RX signal strength and provides information about the selected neighbor nodes to the message generator.

15. The MS apparatus of claim 12, wherein the message including the information about the neighbor nodes is a message transmitted to the serving station to perform an initial network entry procedure.

16. The MS apparatus of claim 12, wherein the message generator generates a ranging request message, inserts the information about the neighbor nodes into the ranging request message in Type/Length/Value (TLV) format, and provides the resulting ranging request message to the transmitter.

17. A serving station apparatus for a cellular communication system, comprising:
a database for managing a neighbor node list that is broadcast periodically;
a message processor for processing a message that is received from a Mobile Station (MS) performing an initial network entry procedure; and
a controller for updating the neighbor node list using information of neighbor nodes that is included in a predetermined message received from the MS.

18. The serving station apparatus of claim 17, wherein the serving station is a Base Station (BS) or a Relay Station (RS).

19. The serving station apparatus of claim 17, wherein the neighbor node list includes information about neighbor BSs and neighbor RSs.

20. The serving station apparatus of claim 17, wherein the predetermined message is a message for performing an initial network entry procedure.

21. The serving station apparatus of claim 17, wherein the predetermined message is a ranging request message.

22. A method for constructing a neighbor node list in a cellular communication system, comprising the steps of:
acquiring neighbor nodes at a Mobile Station (MS) through a scanning operation in an initial network entry procedure, inserting information about the acquired neighbor nodes into a predetermined message, and transmitting the predetermined message to a serving station; and
updating a periodically-broadcast neighbor list at the serving station using the information about the neighbor nodes.

23. The method of claim 22, wherein the serving station is a Base Station (BS) or a Relay Station (RS).

24. The method of claim 22, wherein the MS selects a predetermined number of the neighbor nodes among the acquired neighbor nodes in descending order of RX signal strength and transmits information about the selected neighbor nodes to the serving station.

25. The method of claim 22, wherein the predetermined message is a message for performing an initial network entry procedure.

26. The method of claim 22, wherein the predetermined message is a ranging request message.

27. The method of claim 22, wherein the neighbor node list includes information about neighbor BSs and neighbor RSs.

28. The method of claim 22, further comprising:
generating and broadcasting a neighbor node advertisement message including the neighbor node list at the serving station at a TX time point according to a predetermined period.
